(19) United States
(12) Patent Application Publication
(10) Pub. No.: US 2015/0235128 A1
(43) Pub. Date: Aug. 20, 2015

(54) METHOD AND APPARATUS FOR GENERATING MEDIA CAPTURE DATA AND CONTEXT BASED MEDIA BASED ON CROWD-SOURCE CONTEXTUAL DATA

(71) Applicant: Nokia Corporation, Espoo (FI)

(72) Inventors: Sujeet Shyamsundar Mate, Tampere (FI); Igor Danilo Diego Curcio, Tampere (FI)

(21) Appl. No.: 14/181,048

(22) Filed: Feb. 14, 2014

(51) Int. Cl. G06N 5/04

(52) U.S. Cl. CPC G06N 5/04

(57) ABSTRACT

A method, apparatus and computer program product are provided for generating context based media based on crowd sourced contextual data. In one embodiment a method is provided including receiving a first media; receiving contextual data associated with a consumption of a first media; generating an inference based on the contextual data; generating media capture data based on the inference and the first media; transmitting media capture data; and receiving a second media in response to transmitting the media capture data, wherein the second media is based on the media capture data.

### TECHNOLOGICAL FILED

An example embodiment of the present invention relates generally to generation of media and, more particularly, to generate media based on media captured data and context based media based on crowd sourced contextual data.

### BACKGROUND

In the production of professional media content consumer feedback data may be difficult if not impossible to gather and utilize. This is especially true for live event media, or media with a short time between generation and distribution. Additionally, the feedback that can be gotten for longer production time media may not be specific.

Generally, media feedback is accomplished by rating agencies and other services conducting surveys. These surveys even when given contemporaneously with the media consumption may have limited options for response or periods for response. Further, these surveys are not instantaneous and required dedicated effort, time, and may have substantial costs. All of these reasons may preclude some groups form using these services, such as amateur groups.

The survey feedback is limited by the specific questions asked and may not be useful to groups that did not generate or take part in the generation of the survey. For example, the survey may have the wrong demographic, wrong questions, wrong timing of questions, wrong media, wrong media view or single media view when multiple views are available, or the like.

The limitations of media feedback surveys combined with the costs and time required tend to limit such surveys to only high revenue recurring events and media.

### BRIEF SUMMARY

A method, apparatus and computer program product are provided in accordance with an example embodiment in order to facilitate capturing media based on a media capture data and generating context based media based on crowd sourced contextual data. Traditional consumer media feedback cannot augment the media so that implicit reactions to the media are embedded as metadata which can be shared with other users. For example family and friends may “relive” the first consumer's reactions while viewing the media during subsequent viewings of the media. Similarly, traditional professional media does not have an automatic crowd-sourced cues or “context” to modify the media or subsequent media to be more appealing to consumers.

The present invention allows for various user equipment (UE) to capture consumer context data as the media is being consumed. For example, devices such as smart phones, personal data assistants (PDAs), tablet computers, or the like equipped with positioning sensors, accelerometers, eye-tracking, microphones, gyroscopes, compasses, and the like may take collect contextual data during consumption of the media. In another example, a motion sensing input device, such as a Microsoft Kinect or similar device, may be used to track a consumer's motion and audio input.

The contextual data may be further refined by adding self-selection parameters or social context, such as age, race, sex, affiliations, likes, friends, relationships, or the like. The contextual data may be utilized by embedding the information into the media for later viewing or augmenting the media or subsequent media to conform more closely to the consumer desires. The contextual data may also be used to determine inferences, which may be utilized to generate media capture data or instructions that can be transmitted to UEs and production cameras to capture media desired by the consumer. In an example embodiment a method is provided including receiving a first media; receiving contextual data associated with a consumption of a first media; generating an inference based the contextual data; generating media capture data based on the inference and the first media; transmitting media capture data; and receiving a second media in response to transmitting the media capture data, wherein the second media is based on the media capture data. In an example embodiment of the method, the first media is consumed in a user equipment by a user and the contextual data is further associated with at least one of the user equipment, the user and the first media.

In an example embodiment of the method, the contextual data is based on sensor data. The method of the example embodiment may also include generating a context based media based on the first media, the second media, and the inference. The method of an example embodiment may also include causing the transmission of the context based media. In an example embodiment of the method, the media capture data is transmitted to a production camera or a user equipment. The method of an example embodiment may also include receiving context based media. In the method of this embodiment, the generating media capture data is further based on the context based media.

The method of an example embodiment may also include receiving social context data. In the method of this embodiment, the generating media capture data is further based on the social context data. The method of an example embodiment may also include generating a plurality of inferences based on the contextual data; generating composite inferences based on the plurality of inferences. In the method of this embodiment, the generating media capture data is further based on the composite inferences.

In another example embodiment, an apparatus is provided that includes at least one processor and at least one memory including computer program code with the memory and computer program code configured to, with the processor, cause the apparatus to receive a first media; receive contextual data associated with a consumption of a first media; generate an inference based on the contextual data; generate media capture data based on the inference and the first media; transmit media capture data; and receive a second media in response to transmitting the media capture data, wherein the second media is based on the media capture data. In an example embodiment of the apparatus, the first media is consumed in a user equipment by a user and the contextual data is further associated with at least one of the user equipment, the user and the first media.

In an example embodiment of the apparatus, the contextual data is based on sensor data. The at least one memory and computer program code may be further configured to, with the processor, cause the apparatus of an example embodiment to generate a context based media based on the first media, the second media, and the inference data. The at least one memory and computer program code may be further configured to, with the processor, cause the apparatus of an example embodiment to cause the transmission of the context based media. In an example embodiment of the apparatus, the media capture data may be transmitted to a production camera or a user equipment.

The at least one memory and computer program code may be further configured to, with the processor, cause the apparatus of an example embodiment to receive context based media; and the generating media capture data is further based on the context based media. The at least one memory and computer program code may be further configured to, with the processor, cause the apparatus of an example embodiment to receive social context data; and the generating media capture data is also based on the social context data. The at least one memory and computer program code maybe configured to, with the processor, cause the apparatus to generate a plurality of inferences based on the contextual data; generate composite inferences based on the plurality of inferences; and the generating media capture data is further based on the composite inferences.

In a further embodiment, a computer program product is provided that includes at least one non-transitory computer readable medium having program code portions stored thereon with the program code portions configured, upon execution, to receive a first media; receive contextual data associated with a consumption of a first media; generate an inference based on the contextual data; generate media capture data based on the inference and the first media; transmit media capture data; and receive a second media in response to transmitting the media capture data, wherein the second media is based on the media capture data. In an example embodiment of the computer program product, the first media is consumed in a user equipment by a user and the contextual data is further associated with at least one of the user equipment, the user and the first media.

In an example embodiment of the computer program product the contextual data is based on sensor data. The computer-executable program code portions of an example embodiment may also include program instructions to generate a context based media based on the first media, the second media, and the inference. The computer-executable program code portions of an example embodiment may also include program instructions to cause the transmission of the context based media. In an example embodiment of the computer program product the media capture data is transmitted to a production camera or a user device. The computer-executable program code portions of an example embodiment may also include program instructions to receive context based media; and the generating media capture data is further based on the context based media.

The computer-executable program code portions of an example embodiment may also include program instructions to receive social context data; and the generating media capture data is also based on the social context data. The computer-executable program code portions of an example embodiment may also include program instructions to generate a plurality of inferences based on the contextual data; generate composite inferences based on the plurality of inferences; and the generating media capture data is further based on the composite inferences.

In yet another example embodiment, an apparatus is provided that includes means for receiving a first media; receiving contextual data associated with user equipment, wherein the contextual data further associated with a consumption of a first media; means for generating an inference from the contextual data; means for generating media capture data based on the inference and the first media; means for transmitting media capture data; and means for receiving a second media in response to transmitting the media capture data, wherein the second media is based on the media capture data.

In an example embodiment, a method is provided including receiving a media capture data, wherein the media capture data is based on an inference and a first media; capturing a second media based on the media capture data; and causing the transmission of the second media. In an example embodiment of the method, the media capture data includes a media capture direction. In an example embodiment of the method, the media capture data includes camera control data.

In an example embodiment, an apparatus is provide including at least one processor and at least one memory including computer program code, the at least one memory and computer program code configured to, with the processor, cause the apparatus at least to: receive a media capture data, wherein the media capture data is based on an inference and a first media; capture a second media based on the media capture data; and cause the transmission of the second media. In an example embodiment of the apparatus, the media capture data includes a media capture direction. In an example embodiment of the apparatus, the media capture data includes camera control data.

In an example embodiment a computer program product is provided that includes a non-transitory computer readable medium having program code portions stored thereon, the program code portions configured, upon execution to: receive a media capture data, wherein the media capture data is based on an inference and a first media; capture a second media based on the media capture data; and cause the transmission of the second media. In an example embodiment of the computer program product, the media capture data includes a media capture direction. In an example embodiment of the computer program product, the media capture data includes camera control data.

In yet another example embodiment, an apparatus is provided that includes means for receiving a media capture data, wherein the media capture data is based on an inference and a first media; means for capturing a second media based on the media capture data; and means for causing the transmission of the second media.

In an example embodiment, a method is provided including receiving a media or media identifier; generating contextual data during the consumption of the media; and causing the transmission of the contextual data.

In an example embodiment, an apparatus is provided including at least one processor and at least one memory including computer program code, the at least one memory and computer program code configured to, with the processor, cause the apparatus at least to: receive a media or media identifier; generate contextual data during the consumption of the media; and cause the transmission of the contextual data.

In an example embodiment, a computer program product is provided including a non-transitory computer readable medium having program code portions stored thereon, the program code portions configured, upon execution to: receive a media or media identifier; generate contextual data during the consumption of the media; and cause the transmission of the contextual data.

In yet another example embodiment, an apparatus is provided that includes means for receiving a media or media identifier; means for generating contextual data during the consumption of the media; and means for causing the transmission of the contextual data.

### BRIEF DESCRIPTION OF THE SEVERAL VIEWS OF THE DRAWINGS

Having thus described example embodiments of the invention in general terms, reference will now be made to the accompanying drawings, which are not necessarily drawn to scale, and wherein:

FIG. 1 illustrates an exemplary data flow path for viewer based context data in accordance with an example embodiment of the present invention;

FIG. 2 illustrates an exemplary contextual extractions system in accordance with an example embodiment of the present invention;

FIG. 3 illustrates elementary and composite inferences over media time in accordance with an example embodiment of the present invention;

FIG. 4 illustrates a comparison of a conventional director's cut and a feedback based director's cut in accordance with an example embodiment of the present invention;

FIG. 5 is a block diagram of an apparatus that may be specifically configured for capturing media based on media capture data and generating context based media in accordance with an example embodiment of the present invention;

FIGS. 6 and 7 are flowcharts illustrating media consumption and creation ecosystems in accordance with example embodiments of the present invention; and

FIGS. 8-10 are a flowcharts illustrating the operations performed, such as by the apparatus of FIG. 5, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

### Example Data Flow Path for Viewer Based Context Information

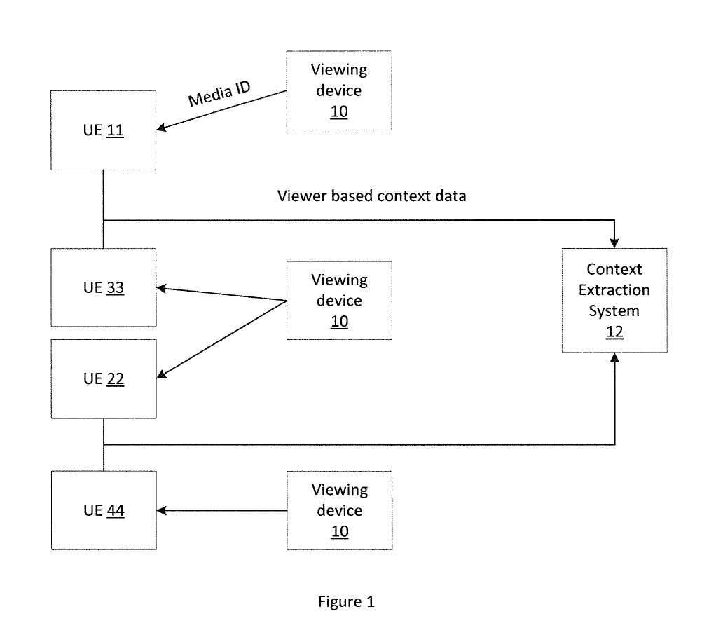

A method, apparatus and computer program product are provided in accordance with an example embodiment to generate context based media based on crowd sourced contextual data. FIG. 1 illustrates an exemplary data flow path for viewer based context data. A viewing device 10 may be configured to transmit an indication of the media identifier to the user equipment (UE) 11, 22, 33, or 44. The media may be a single view or multiple views of an event or program. The viewing device 10 may be a separate unit from the UE 11, such as a television or computer monitor. In an example embodiment, the viewing device 10 may be a portion of the UE 11, such as the user interface of a smart phone, PDA, tablet computer, or the like.

The viewing device 10 may transmit the media identifier to the UE 11 by Wi-Fi, BLE, NFC, or the like. The viewing device 10 may transmit the media identifier to multiple UEs in within a predetermined range, such as UEs 22 and 33. For example, if two or more users are watching a television, each carrying a smartphone, the television may transmit the media ID to each of the smartphones. The viewing devices 10 may be in different locations and displaying the same media at the same of different times. For example, viewing devices 10 may display a sporting event, movie, or recurring program on viewing devices throughout the world at the same time, staggered times, or on consumer demand.

In an example embodiment, the UE 11 may create the media by capturing audio and visual content. The captured audio and visual content may be associated with a media identifier and contextual data that is collected as described below.

The UE 11 may be a mobile device, such as smartphones, personal data assistants (PDAs), tablet computers, or the like equipped with positioning sensors, accelerometers, eye-tracking, microphones, gyroscopes, compasses, and the like may take collect contextual data during consumption of the media. In another example, the UE 11 may be a stationary motion sensing input device, such as a Microsoft Kinect or similar device, which may be used to collect motion and audio contextual data. The UE 11 may collect measurements and changes in measurements as contextual data “events”.

In some embodiments, the user may also use a user interface to directly indicate positive or negative reactions, or make media content selections. Contextual data may include without limitation, motion events, e.g. movements based on gyroscopes, accelerometers, or motion sensing; audio events, such as sounds captured by microphones or vibration sensors; visual events, such as images captured by a camera, or motion sensor; gesture events such as hand movements measured by accelerometers, gyroscopes, or motion sensors; group events such as the movement of more than one user, or a NFC or BLE indication of other UEs 22, 33, or 44; emotional events such as, increased pupil dilation, heart rate or skin moisture, or the like. Any change in a single or multiple sensor measurement may be an event which is associated with a timestamp and transmitted by the UE 11. In an example embodiment, sensor measurements may have to change by a predetermined amount or in conjunction with one or more other sensors to be considered an event.

In an example embodiment, the UE 11 may be associated with a user interface which the user may select from choices available, such as positive reactions, negative reactions, or desired camera view.

Additionally, the user may provide social context data by self-selection. For example, the user may identify their sex, race, location, occupation, age, affiliations, friends, relationships, family, or the like. In an example embodiment, the user's social context data may be accessed through social media sites.

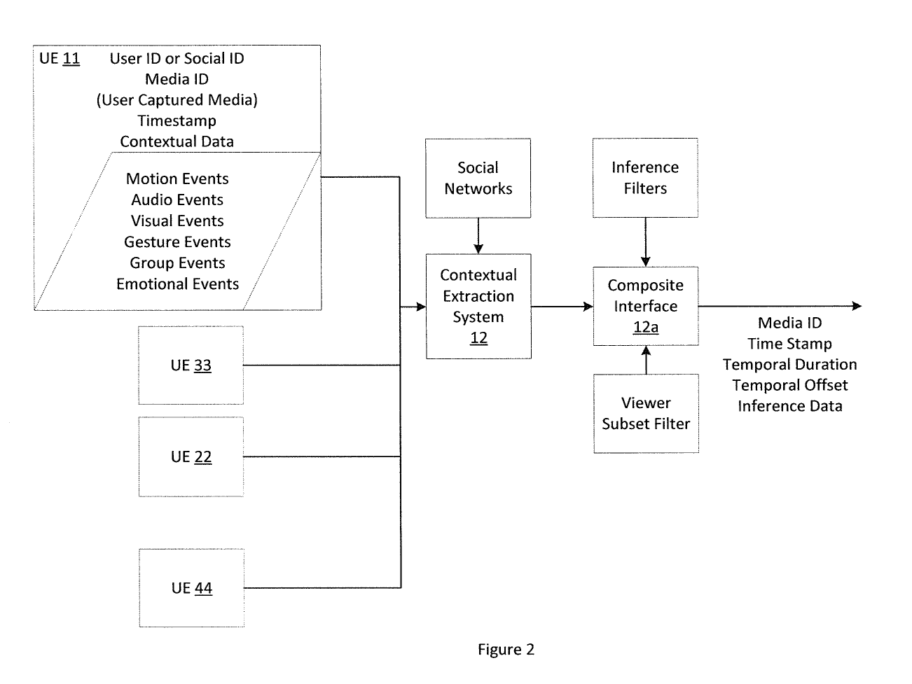

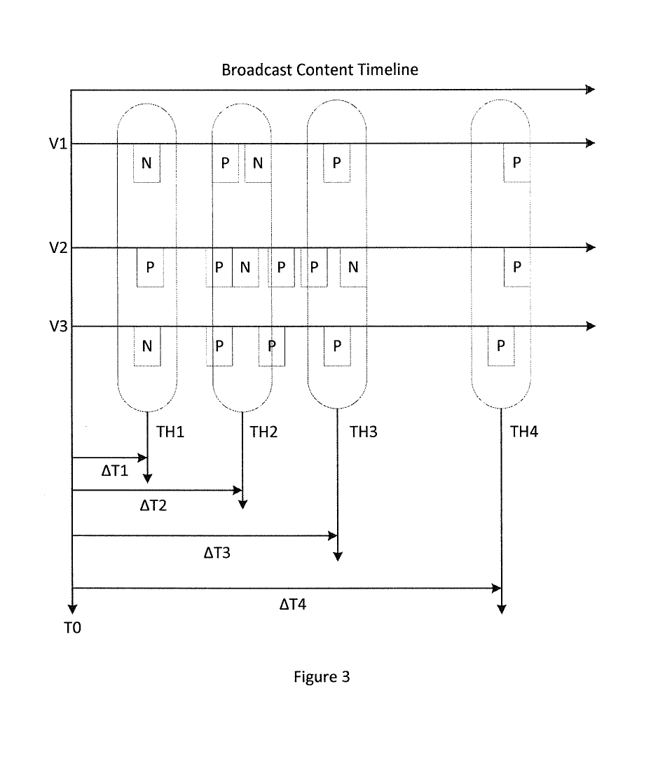

The contextual data is sent from the UE 11 to the context extraction system 12. The contextual data may include context data collected form a single UE 11, multiple UEs, proximate UE 11 data, social context data, or the like. The content extraction system 12 may extract individual context data and correlate and extract group context data, as further described in FIGS. 2 and 3. The content extractions system 12 may generate elementary inferences based on the extracted context data which is also discussed below in FIGS. 2 and 3.

The context extraction system 12 may generate composite inferences based on the elementary inferences, such as positive responses and negative responses to portions of media content or the duration of the media content. The content extraction system 12 may use the composite inferences to generate context based media. Context based media may be generated by embedding the media identified by the media identifier metadata and/or altering the media itself. In an example embodiment, the social context data is embedded into the media for later use in determining who has watched the media. The metadata can be used for generation of demographics of the viewers, without use of surveys. In other example embodiments, the reaction of the viewers based on inferences may be embedded as metadata. Subsequent users may be able to see the reactions, positive and negative, contemporaneously with the media content.

In another example, context based media is altered media which may be the highlights of a sporting event with the largest reactions, a summary of a movie, program or event based on portions with the largest reactions based on the composite inferences, or the like. In some embodiments, the social context data may be used to further alter the media. For example, fan specific highlights for particular teams, or players. Examples of metadata embedded media may include social network feedback. In an example embodiment, both embedding the context metadata and altering the media may be performed. For example, synergistic media wherein the media and reactions multiple media viewings may be merged into a single media or series of media, such as a viewed content highlights summery or overview with reactions or the viewers.

In another example, media covering an event may be generated by multiple sources; the context based media may be portions of each of the sources that have the highest reaction based on composite inferences. The metadata may highlight portions of each source to skip and portions that should be included. The context based media may include only the portions designated for inclusion.

In other example embodiments, the context based media data is generated on a short delay after being captured and may be transmitted as the first viewing for other viewers. This allows for a select group of viewers to interactively determine the contents of the context based media that is transmitted to a wider audience.

In an example embodiment the composite inferences may be used to generate media capture data. The media capture data may comprise the inference data or direction for media capture, which a user may use to capture media with a UE 11. In an example embodiment the media capture data may be camera control data which may cause a production camera or UE to change angle, focus, ambient lighting or the like to capture media. For example, the media capture data may indicate or cause the production camera or UE to capture more close-ups of a given scene or a different camera angle.

### Example Contextual Extraction System

FIG. 2 illustrates an exemplary contextual extractions system. The UE 11 may capture and collect data for transmission to the contextual extraction system 12. The captured or collected data may include, without limitation, user ID, social ID, media ID and/or user captured media, timestamp data, and contextual data. The UE 11 may receive the media ID as discussed in FIG. 1 or create or capture media using cameras, microphones and other associated sensors. The UE 11 may receive user ID such as name, login, or other identifier from the user. Additionally, the UE 11 may receive a social ID, such as social media site user ID, affiliations database ID, or other identifiers.

The UE 11 may timestamp the media ID and/or the contextual data for correlation of the contextual data and portion of the media at a later point. Contextual data may be collected by the UE 11 using various sensors associated with the UE during the consumption of the media, such as heart rate monitor, moisture monitor, positioning sensors, accelerometers, eye-tracking, microphones, gyroscopes, compasses, motion sensors, or the like. In some embodiments, the user may also use a user interface to directly indicate positive or negative reactions, or make media content selections, such as camera view. Contextual data may include, without limitation, motion events, e.g. movements based on gyroscopes, accelerometers, or motion sensing; audio events, such as sounds captured by microphones or vibration sensors; visual events, such as images captured by a camera, or motion sensor; gesture events such as hand movements measured by accelerometers, gyroscopes, or motion sensors; group events such as the movement of more than one user, or a NFC or BLE indication of other UEs 22, 33, or 44; emotional events such as, increased pupil dilation, heart rate or skin moisture, or the like. Any change in a single or multiple sensor measurement may be an event which is associated with a timestamp and transmitted by the UE 11. In an example embodiment, sensor measurements may have to change by a predetermined amount or in conjunction with one or more other sensors to be considered an event.

In an example embodiment, contextual data may include social context data which may be self-selected by the user and transmitted by the UE 11 with other contextual data, entered into a database which, the contextual extraction system 12 may access and identify based on the user ID, compiled from social media sites by the contextual extraction system using the social ID, or the like. Social context data may include without limitation, the user's sex, race, location, occupation, age, affiliations, friends, relationships, family, or the like.

The UE 11 transmits the user ID, social ID, media ID, user captured media, timestamps, and contextual data to the contextual extraction system 12. The contextual extraction system 12 may extract individual or group context data from the data received from the UEs 11. The extraction of individual context data may include compiling contextual data based on individuals. The contextual data may be identified with the user identifier and the social contextual data. The extracted individual contextual data therefore provides context data that can be selected by any one or more attributes of the social context data or the user identifier.

In an example embodiment, the contextual extraction system 12 may also extract group context data. Extraction of group context data may include compiling contextual data based on relationships, location, affiliations or the like. For example, a group of persons watching an event together in a home, a theater, or the event location e.g. game or concert. In another example, the group may be persons that have identified themselves as fans of a particular show, actor, player, performer, or the like by self-selection or social media. In another example, the group may be friends of family members as self-selected by the user and/or social media.

In an example embodiment, the contextual extraction system 12 may generate elementary inferences based on individual context data and each event. The elementary inferences may associate positive and negative reactions to events or simply identify or classify events. For example, an audio event may be loud noises, which the contextual extraction system 12 identifies as cheering (positive), or booing or yelling (negative). In another example, the motion event may be movement based on motion sensors, accelerometers, or the like, which the contextual extraction system 12 identifies as standing (positive), sitting down (negative). In yet another example, an event may be a change in heart rate based on a heart rate sensor, which the contextual extractions system 12 identifies as increased heart rate (positive), decreased heart rate (negative), or the like. Social context data may be appended to the elementary inference for use by the composite interface 12a.

The contextual extraction system 12 provides the extracted individual or group context data, and elementary inferences to the composite interface 12a. The composite interface 12a may be a separate unit or a portion of contextual extraction system 12. The composite interface 12a may be programmed or have access to various inference filter profiles. The composite interface 12a compiles individual and group context data and elementary inferences to generate a composite inference. The composite inference may be inference information of an individual over a period or the length of the media, or group inference information for a period or duration of the media. For example, users may be grouped according to their positive or negative reactions to specific media or portions of media. The social context data may be used to determine subsequent inferences. In another example embodiment, a viewer subset filter may be used to determine the convergence or divergence between a pre-selected group of users to determine the effect of certain content on a specified group of users and/or demographics. For example, cheer sounds from some users, cotemporaneous with jumping form the same or other users of the group may indicate a positive group inference for a group possible watching a sporting event. Similarly, a negative inference from an individual or group at the same or overlapping time may be inferred as groups supporting the opposing team.

An example of elementary and composite inferences or viewer reactions at different times is shown in FIG. 3. Viewer negative reactions are depicted with an “N”, positive reactions are depicted with a “P”. Using the above example it may be inferred that viewers 1 and 3 may be supporting the same team or have similar tastes in media, whereas viewer 2 is supporting an opposing team or has dissimilar interests in media.

The composite interface 12a may output the media ID, timestamp, temporal duration, temporal offset, and inference data. The data output by the composite interface may be used to generate context based media.

### Comparison of Director's Cut to Context Based Media

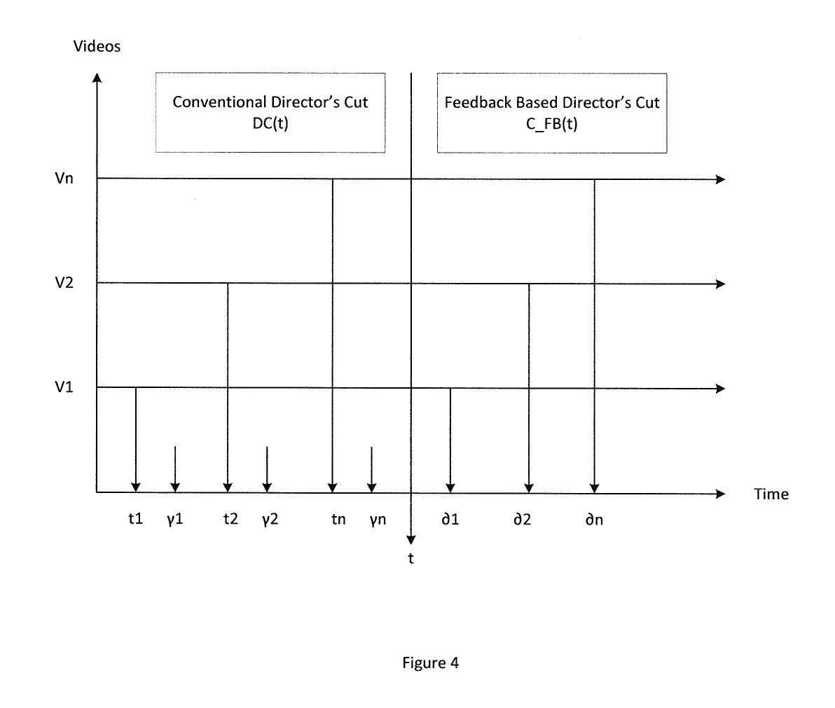

FIG. 4 illustrates a comparison of a conventional director's cut and a feedback based director's cut. The conventional director's cut cannot influence the next generation of source material, instead it is limited to the material available. Any future material is dependent on random/arbitrary media creation. The conventional directors' cut also does not support change to the editing rules for media creation. A director's cut “DC” created at time instant “t” is a function of all the media in the example videos “V1, V2, . . . Vn” and in some cases viewer feedback or contextual data that is available until time “t”. The director's cut does not have visibility to media or ability to influence media that has not arrived yet.

DC(t)=f1(V1ₜ₁,V2ₜ₂, . . . , Vnₜₙ)

tᵢ<t; ∀i=1,2, . . . , n

In contrast, the feedback based director's cut “C_FB” enables the media capture, editing and production rules to be changed dynamically based on the viewer feedback until that time. Therefore, future media (V1_{∂1}, V2_{∂2}, Vn_{∂n}) capture may be influenced based on the media and context data received before that time. The media and context data may be used to generate inferences at γ1, γ2, γn which may be used to generate media capture data or feedback. The media capture data may be used to capture media at ∂1, ∂2, ∂n in accordance with media capture data. C_FB may be a function of the context based media generated based on the media created before time t and the future media created after time t based on the previously received media and context data.

C_{—}FB(t)=f2((V1_{∂1},V2_{∂2},Vn_{∂n},F_{γ1},F_{γ2},F_{γn})

∂ᵢ≧t; ∀i=1,2 . . . n; tᵢ≦γᵢ≦t; i=1,2, . . . , n

During the production of media, the selection of scenes and actors may be based on the viewer feedback or inference data. For example, in a media series if an actor becomes increasingly popular the directing rules or filming techniques may be changed to include more scenes including the actor. In an instance in which the media is a live event, such as a sporting event, concert, social event, or the like, the media may be tuned in accordance with the feedback form an individual, group, or all viewers. For example, selecting a camera or cameras that include images of what the viewer's desire to see based on the media capture data, such as close up of the snap, in football, stage area with the lead singer of a concert performance group, or the like. The selection of the media or media views may be performed manually, such as by a director, or automatically based on the inference data. In an example embodiment, the inference data may be used to highlight portions of media in which the viewers have responded positively or negatively. The director may adapt the story, media capture, or the like to comply with the viewer feedback. During the capture of media the media capture data may be utilized for modifying the media captured from that time onward. The media capture data may comprise the inference data or direction for media capture, which a user may use to capture media or may be automatically captured by a production camera or user equipment. In an example embodiment, the media capture data may be camera control data which may cause a production camera or UE 11 to change angle, focus, ambient lighting, or the like to capture media. For example, the media capture data may indicate or cause the production camera or UE 11 to capture more close-ups of a given scene or a different camera angle. In some embodiments, the media transmitted and viewed by the user may include additional camera views. In an example embodiment, the viewers may participate interactively in the broadcast production by selecting the cameras and/or angles. The result is a context based media which is conformed to the tailored based on the feedback of the viewers.

In some example embodiments, the automatic capture and editing of media based on media capture data or viewer feedback may be limited to ensure specified subject matter is not removed. The automatic capture and editing may be limited automatically by the system or by manual director override, to prevent changes that are not desired by the director. Certain section of the media that is induced may incorporate feedback to a greater degree, whereas for other sections the feedback may be absolute or not allowed. For example, during telecast of a sporting event the game play sections may incorporate media capture data based on changes that do not take away focus form the playing field. During breaks in game play, media capture data or feedback that takes focus away for the playing field may be allowed.

### Exemplary Apparatus

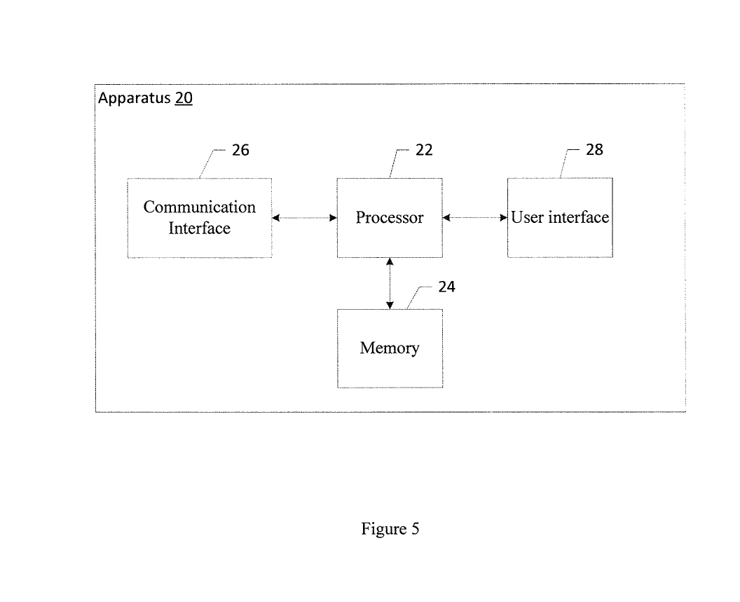

The UE 11, production camera, or content extraction system 12 include or be associated with an apparatus 20. The apparatus, such as that shown in FIG. 5, is specifically configured in accordance with an example embodiment of the present invention to provide for generating media based on media captured data and context based media based on crowd sourced contextual data. The apparatus may include or otherwise be in communication with a processor 22, a memory device 24, a communication interface 26 and an optional user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a mobile device 102. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include a communication interface 26 that may be any means such as a device or circuitry embodied in either hardware or a combination of hardware and software that is configured to receive and/or transmit data from/to a communications device in communication with the apparatus, such as to facilitate communications with one or more smart device 101, remote resource 103, or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 20 may also optionally include a user interface 28 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

### Example Content Creation and Consumption Ecosystem

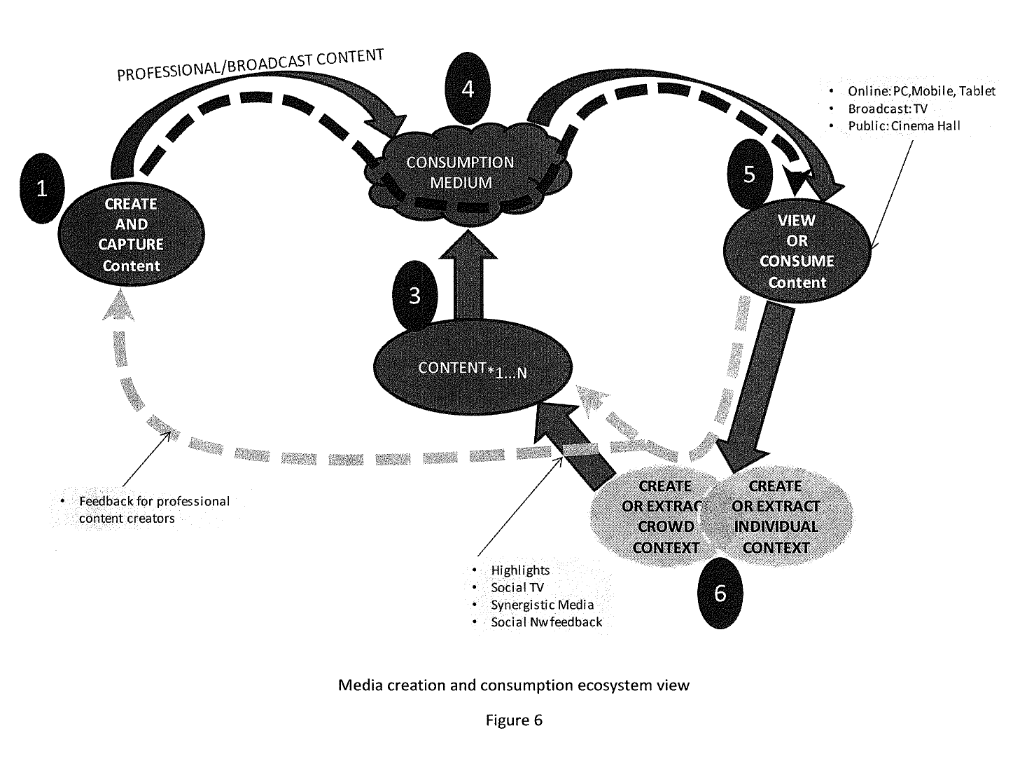

FIG. 6 illustrates an example content creation and consumption ecosystem. The content or media may traverse at least one of two paths through the ecosystem. Path one may include state 1, state 4, state 5, state 6, and then state 3. Path two may include state 1, state 4, state 5, state 6, and then recommencing at state 1. At state 1 professional media content is captured or created.

At state 4, a consumable media, such as a video, is created based on the captured or created content. At state 5 the consumable content is viewed or consumed. For example, the consumable content may be transmitted and consumed using the internet, such as on a computer, mobile device or other UE 11, broadcast using cable or radio frequency communications, displayed in a group forum, such as a theater or cinema hall. Displayed consumable content may also include portable media such as DVDs, CDs, or the like. Contextual data is received at the UE 11 during the consumption or viewing of the media content.

At state 6, the contextual data is received by the contextual extraction system 12. The contextual extraction system may extract individual and group (crowd) context data as discussed in FIG. 2. The contextual extraction system 12 may also may elementary and composite inferences based on the context data as described in FIG. 2.

At state 3, context based media is generated based on the context data or composite inferences derived from state 6, as discussed in FIGS. 1 and 4. Examples of context based media, as discussed in FIGS. 1 and 4, may include highlights of media content based on reactions, social TV with embedded reactions, synergistic media, social network feedback, or the like. The delay from creation and capture of the media to the generation of context based media is based on the method used for consumption of the media. For example, a live broadcast may have a relatively short delay, whereas a media that is recorded and consumed later such as a weekly program, portable media such as a CD, DVD or the like, may have a longer delay.

Additionally, the context data and composite inferences may be used to generate media capture data, which may be used to influence the creation and capture of subsequent media content at state 1. The generation of media capture data is discussed above in FIGS. 1 and 4. Viewer feedback or context data may be used by content creators in determination of future media capture or creation. For example the metadata embedded media as discussed above in FIGS. 1 and 4.

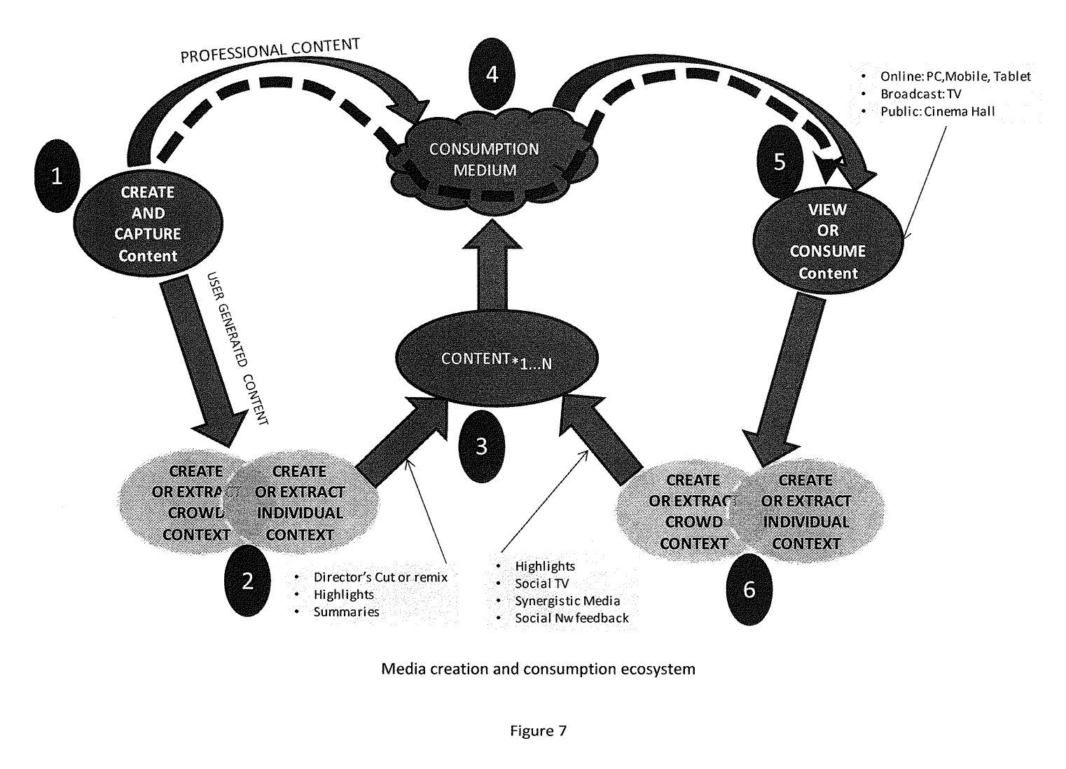

FIG. 7 illustrates an example content creation and consumption ecosystem which includes an additional state, state 2. In this embodiment, the creation or capture of media may include user generated content, such as media generated by a UE. The user generated media content and contextual data may be received from the UE 11 as discussed in FIGS. 1 and 4. The contextual extraction system 12 may extract individual and crowd or group context data from the contextual data at state 2, as discussed in FIG. 2. Additionally, the contextual extraction system may generate elementary and composite inferences associated with the user generated media content.

The composite inferences and user generated media content may be an additional input to the generation of context based media, as discussed above in FIGS. 1 and 4. The contact based media may include a director's cut, a remix of the user generated media content, highlights or summaries including the user generated media, or the like. Further, because the contextual data is generated contemporaneously with the creation of the media and/or the user generated media, minimum delay to generate context based media is reduced.

### Exemplary Process for Generating Media Capture Data and Context Based Media

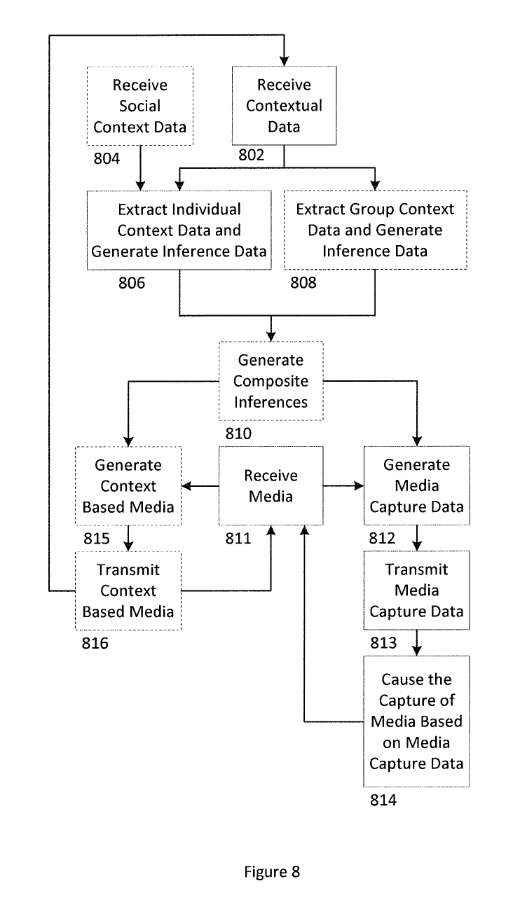

Referring now to FIG. 8, the operations performed, such as by the apparatus 20 of FIG. 5, in order to generate media capture data or context based media based on crowd-sourced contextual data are illustrated. As shown in block 802 of FIG. 8, the apparatus may include means, such as the processor 22 or the like, configured to receive contextual data from a UE 11. In an example embodiment, the contextual data may include, without limitation user identifiers, social identifiers, media identifiers, timestamps, motion events audio events, visual events, gesture events, group events, emotional events, or the like as described in FIGS. 1 and 2. The processor 22 may receive the contextual data from a communication interface 26. The communications interface 26 may receive the contextual data from the UE 11 device using a wired or wireless communication.

As shown in block 804 of FIG. 8, the apparatus 20 may include means, such as a processor 22 or the like, to receive social context data. Social context data may include without limitation, the user's sex, race, location, occupation, age, affiliations, friends, relationships, family, or the like with may be self-selected or retrieved from social media. The processor may receive the social context data from the communications interface 26. The communication interface 26 may receive the social context data from the UE 11 or by retrieving the social context data from social media sites or memory 24. In an embodiment in which the social context data is received from a UE 11, the communications interface 26 may receive the social context data using wired or wired communication. In an embodiment in which the social context data is retrieved from a memory 24, the communication interface 26 may use the user identifier to access presorted user data from the memory. In an embodiment in which the social context data is retrieved from social media sites, the communication interface may access the social media sites using the social identifier over an internet connection.

As shown in block 806 of FIG. 8, the apparatus 20 may include a means, such as a processor 22 or the like, configured to extract individual context data. The extraction of individual context data may include compiling contextual data based on individuals. The contextual data may be identified with the user identifier and the social contextual data. The extracted individual contextual data therefore provides context data that can be selected by any one or more attributes of the social context data or the user identifier. In an example embodiment, the individual contextual data may be used in extraction of group contextual data at 808.

Additionally, the processor 22 may make elementary inferences based on individual context data and each event. The elementary inferences may associate positive and negative reactions to events or simply identify or classify events. For example, an audio event may be loud noises, which the processor 22 identifies as cheering (positive), or booing or yelling (negative). In another example, a motion event may be movement based on motion sensors, accelerometers, or the like, which the processor 22 identifies as standing or jumping (positive), sitting down (negative). In another example, an emotion event may be a change in heart rate, which the processor 22 identifies as an increased heart rate (positive), decreased heart rate (negative). Each elementary inference may be associated with a timestamp and/or the media ID for later use in generating composite inferences and/or generating context based media.

As shown in block 808 of FIG. 8, the apparatus 20 may include means such as a processor 22 or the like, configured to extract group context data. Extraction of group context data may include compiling contextual data and elementary inferences based on relationships, location, affiliations or the like. For example, a group of persons watching an event together in a home, a theater, or the event location e.g. game or concert. In another example the group may be persons that have identified themselves as fans of a particular show, actor, player, performer, or the like by social context data. In another example, the group may be friends of family members as identified by social context data.

As shown in block 810 of FIG. 8, the apparatus 20 may include means, such as a processor 22 or the like, configured to generate composite inferences. The processor 22 may generate composite inferences based on the elementary inferences, extracted individual context data, and/or the extracted group context data. The composite inference may be inference information of an individual over a period or the length of the media, or group inference information for a period or duration of the media. For example, users may be grouped according to their positive or negative reactions to specific media or portions of media. The social context data may be used to determine subsequent inferences. In another example embodiment, a viewer subset filter may be used to determine the convergence or divergence between a pre-selected group of users to determine the effect of certain content on a specified group of users and/or demographics. For example, cheer sounds from some users, cotemporaneous with jumping form the same or other users of the group may indicate a positive group inference for a group possible watching a sporting event. Similarly, a negative inference from an individual or group at the same or overlapping time may be inferred as groups supporting the opposing team. The composite inferences may include media identifier, timestamp, temporal duration, temporal offset, and inference data, e.g. positive or negative reaction. Composite inferences may be used to generate context based media at 815 or to generate media capture data at 812.

As shown in block 811 of FIG. 8, the apparatus 20 may include means, such as a processor 22, communications interface 26, or the like, configured to receive media. The processor 22 may receive the media from a memory 24, a UE 11, or a production camera. In an embodiment in which the processor 22 receives the media from memory 24, the media may include a production media or a context based media as discussed in block 815. The processor 22 may use the media identifier to retrieve the media. In an embodiment in which the media is created in association with the UE 11, or a production camera, such as capturing audio and visual data during a sporting event or concert, the media may be received by the communications interface 26. In an example embodiment, the media created or captured by the UE 11 may be in response to media capture data, as discussed in block 814. The communications interface 26 may receive the media from the UE 11 or production camera using wired or wireless communication.

As shown in block 812 of FIG. 8, the apparatus 20 may include means, such as a processor 22 or the like, configured to generate media capture data. Media capture data may be based on composite inference data and at least one media. In an example embodiment, the media capture data may comprise media capture direction based on the composite inference data. In an example embodiment the media capture data may be camera control data which may cause a production camera or UE 11 to change angle, focus, ambient lighting, or the like to capture media. For example, the media capture data may indicate to capture more close-ups of a given scene or a different camera angle.

As shown in block 813 of FIG. 8, the apparatus 20 may include means, such as a processor 22, communications interface 26, or the like to transmit the media capture data. The processor 22 may cause the communications interface 26 to transmit the media capture data. The communications interface 22 may transmit the media capture data to a user equipment, such as a mobile device, or to a production camera.

As shown in block 814 of FIG. 8, the apparatus may include means, such as a processor 22 communications, interface 26, or the like configured to cause the capture of media based on the media capture data. The processor 22 may cause a production camera or UE 11 to execute the media capture data when received by the UE 11, which may in turn transmit the media to the apparatus 20 or media storage database. In an example embodiment, the media capture data may contain instructions for a user to capture the media based on the media capture data.

As shown at block 815 of FIG. 8, the apparatus 20 may include means, such as the processor 22 or the like, configured to generate context based media. The processor 22 may generate context based media based on the composite inferences, original media, media captured based on the media capture data, or previously generated context based media. Context based media may be generated by embedding the media identified by the media identifier with metadata and/or altering the media itself. In an example embodiment, the social context data is embedded into the media for later use in determining who has watched the media. The metadata can be used for generation of demographics of the viewers, without use of surveys. In other example embodiments, the reaction of the viewers based on inferences may be embedded as metadata. Subsequent users may be able to see the reactions (positive and negative) with the media content.

In another example, context based media is altered media which may be the highlights of a sporting event with the largest reactions, a summary of a movie, program or event based on portions with the largest reactions based on the composite inferences, or the like. In some embodiments, the social context data may be used to further alter the media. For example, fan specific highlights for particular teams, or players. Examples of metadata embedded media may include social network feedback. In an example embodiment, both embedding the context metadata and altering the media may be performed. For example, synergistic media wherein the media and reactions multiple media viewings may be merged into a single media or series of media, such as a viewed content highlights summery or overview with reactions or the viewers.

In another example, media covering an event may be generated by multiple sources; the context based media may be portions of each of the sources that have the highest reaction based on composite inferences. The metadata may highlight portions of each source to skip and portions that should be included. The context based media may include only the portions designated for inclusion.

In other example embodiments, the context based media data is generated on a short delay after being captured and may be transmitted as the first viewing for other viewers. This allows for a select group of viewers to interactively determine the contents of the context based media that is transmitted to a wider audience.

In an example embodiment, the context based media may include media portions based composite inferences, portions of the previously generated context based media based on composite inferences, media captured based on media capture data, or any combination thereof.

As shown in block 816 of FIG. 8, the apparatus 20 may include means, such as the processor 22 or the like, configured to cause the transmission of context media. The processor may cause the communications interface 26 to transmit the context media to various viewing devices 10. In some example embodiments, the processor 22 may cause the context media data to be stored in a memory 24 for later transmission or use in the next iteration of generating media capture data at 812 or context based media at 815. The process may continue at 811 receiving media or 802 receiving contextual data.

### Example Process to Capture Media Based on Media Capture Data

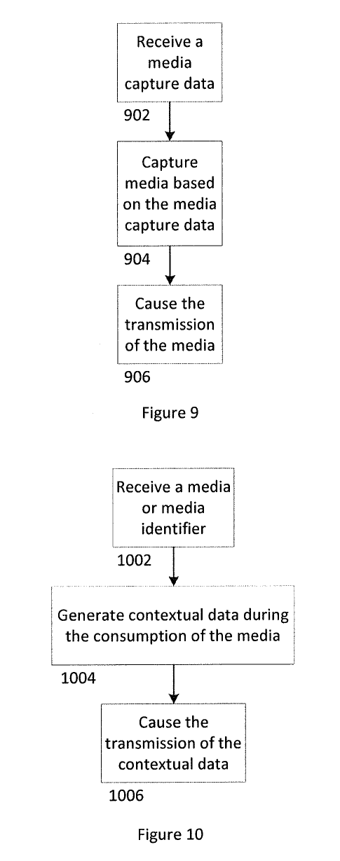

Referring now to FIG. 9, the operations performed, such as by the apparatus 20 of FIG. 5, in order to capture media based on media capture data are illustrated. As shown in block 902 of FIG. 9, the apparatus may include means, such as the processor 22, communications interface 26, or the like, configured to receive a media capture data from a context extraction system 12. The processor 22 may receive the media capture data from the communications interface 26. The communications interface 26 may receive the media capture data from the contest extraction system 12 through wired or wireless communication.

As shown in block 904 of FIG. 9, the apparatus may include means, such as a processor 22 and a user interface 28, to capture media based on the media capture data. Media capture data may be based on composite inference data and at least one media. In an example embodiment, the media capture data may be camera control data which may cause a production camera or UE 11 to change angle, focus, ambient lighting, or the like to capture media. For example, the media capture data may indicate to capture more close-ups of a given scene or a different camera angle, more lighting, or the like.

In an example embodiment, the media capture data may comprise media capture direction based on the composite inference data. The processor 22 may cause the media capture direction to be displayed on a user interface 28. The user may execute the media capture direction capturing media based on the media capture data. For example, the media capture direction may indicate to capture media with a specific actor or player, specific focus full scene or close up, or the like.

As shown in block 906 of FIG. 9, the apparatus may include means, such as a processor 22, a communications interface 26, of the like to transmit the media based on media capture data. The processor 22 may cause the communications interface 26 to transmit the media to the context extraction system 12 or media storage through wired or wireless communication.

### Example Process to Generate Contextual Data

Referring now to FIG. 10, the operations performed, such as by the apparatus 20 of FIG. 5, in order to generate contextual data. As shown in block 1002 of FIG. 10, the apparatus may include means, such as the processor 22, communications interface 26, or the like, configured to receive a media. The media may be a single view or multiple views of an event or program. The media may also include a media identifier. The processor 22 may receive the media from the communications interface 26. The communications interface may receive the media from various sources, such as portable media, broadcast, interne, or the like, through wired or wireless communication.

In some example embodiments, the media may be viewed on a viewing device 10 and the media identifier is received by the apparatus 20. The media identifier identifies the media that is being consumed in association with the UE 11.

As shown in block 1004 of FIG. 10, the apparatus 20 may include means, such as a processor 22, a user interface 28, or the like configured to generate contextual data during the consumption of the media. The processor 22 may receive sensor input from the user interface 28. The processor 22 may generate contextual data by associating a time based on the media or media identifier with the sensor data. In an example embodiment, the contextual data may include, without limitation user identifiers, social identifiers, media identifiers, timestamps, motion events audio events, visual events, gesture events, group events, emotional events, or the like as described in FIGS. 1 and 2.

In an example embodiment, the processor may also associate social context data with the contextual data. Social context data may include without limitation, the user's sex, race, location, occupation, age, affiliations, friends, relationships, family, or the like.

As shown in block 1006 of FIG. 10, the apparatus may means, such as a processor 22, a communications interface or the like, configured to cause the transmission of the contextual data. The processor 22 may cause the communications interface 26 to transmit the contextual data. The communications interface 26 may transmit the contextual data to the context extraction system 12 or to a memory or storage through wired or wireless communication.

As described above, FIGS. 8, 9, and 10 illustrate a flowcharts of an apparatus 20, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of blocks 804, 808, 815, and 816 in FIG. 8. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a first media;
receiving contextual data associated with a consumption of a first media;
generating an inference based on the contextual data;
generating media capture data based on the inference and the first media;
transmitting media capture data; and
receiving a second media in response to transmitting the media capture data, wherein the second media is based on the media capture data.

2. The method of claim 1, wherein the first media is consumed in a user equipment by a user and the contextual data is further associated with at least one of the user equipment, the user, and the first media.

3. The method of claim 1, wherein the contextual data is based on sensor data.

4. The method of claim 1 further comprising:
generating a context based media based on the first media, the second media, and the inference.

5. The method of claim 4 further comprising:
causing the transmission of the context based media.

6. The method of claim 1, wherein the media capture data is transmitted to a production camera or a user equipment.

7. The method of claim 1 further comprising:
receiving first context based media; and
wherein the media capture data further comprises generating a second context based media based on the first context based media.

8. The method of claim 1 further comprising:
receiving social context data; and
wherein the generating media capture data is further based on the social context data.

9. The method of claim 1 further comprising:
generating a plurality of inferences based on the contextual data;
generating composite inferences based on the plurality of inferences; and
wherein the generating media capture data is further based on the composite inferences.

10. An apparatus comprising at least one processor and at least one memory including computer program code, the at least one memory and computer program code configured to, with the processor, cause the apparatus at least to:
receive a first media;
receive contextual data associated with a consumption of a first media;
generate an inference based on the contextual data;
generate media capture data based on the inference and the first media;
transmit media capture data; and
receive a second media in response to transmitting the media capture data, wherein the second media is based on the media capture data.

11. The apparatus of claim 10, wherein the first media is consumed in a user equipment by a user and the contextual data is further associated with at least one of the user equipment, the user, and the first media.

12. The apparatus of claim 10, wherein the contextual data is based on sensor data.

13. The apparatus of claim 10, wherein the at least one memory and the computer program code are configured to, with the processor, cause the apparatus to:
generate a context based media based on the first media, the second media, and the inference.

14. The apparatus of claim 13, wherein the at least one memory and the computer program code are configured to, with the processor, cause the apparatus to:
cause the transmission of the context based media.

15. The apparatus of claim 10, wherein the media capture data is transmitted to a production camera or a user equipment.

16. The apparatus of claim 10, wherein the at least one memory and the computer program code are configured to, with the processor, cause the apparatus to:
receive context based media; and
wherein the generating media capture data is further based on the context based media.

17. The apparatus of claim 10, wherein the at least one memory and the computer program code are configured to, with the processor, cause the apparatus to:
receive social context data; and
wherein the generating media capture data is further based on the social context data.

18. The apparatus of claim 10, wherein the at least one memory and the computer program code are configured to, with the processor, cause the apparatus to:
generate a plurality of inferences based on the contextual data;
generate composite inferences based on the plurality of inferences; and
wherein the generating media capture data is further based on the composite inferences.

19. A computer program product comprising a non-transitory computer readable medium having program code portions stored thereon, the program code portions configured, upon execution to:
receive a first media;
receive contextual data associated with a consumption of a first media;
generate an inference based on the contextual data;
generate media capture data based on the inference and the first media;
transmit media capture data; and
receive a second media in response to transmitting the media capture data, wherein the second media is based on the media capture data.

20. The computer program product of claim 19, wherein the first media is consumed in a user equipment by a user and the contextual data is further associated with at least one of the user equipment, the user, and the first media.

21. The computer program product of claim 19, wherein the contextual data is based on sensor data.

22. The computer program product according to claim 19, wherein the program code portions are further configured, upon execution:
generate a context based media based on the first media, the second media, and the inference.

23. The computer program product according to claim 21, wherein the program code portions are further configured, upon execution:
cause the transmission of the context based media.

24. The computer program product of claim 19, wherein the media capture data is transmitted to a production camera or a user equipment.

25. The computer program product according to claim 19, wherein the program code portions are further configured, upon execution:
receive context based media; and
wherein the generating media capture data is further based on the context based media.

26. The computer program product according to claim 19, wherein the program code portions are further configured, upon execution:
receive social context data; and
wherein the generating media capture data is further based on the social context data.

27. The computer program product according to claim 19, wherein the program code portions are further configured, upon execution:
generate a plurality of inferences based on the contextual data;
generate composite inferences based on the plurality of inferences; and
wherein the generating media capture data is further based on the composite inferences.

28. A method comprising:
receiving a media capture data, wherein the media capture data is based on an inference and a first media;
capturing a second media based on the media capture data; and
causing the transmission of the second media.

29. The method of claim 28, wherein the media capture data comprises a media capture direction.

30. The method of claim 29, wherein the media capture data comprises a camera control data.

31. An apparatus comprising at least one processor and at least one memory including computer program code, the at least one memory and computer program code configured to, with the processor, cause the apparatus at least to:
receive a media capture data, wherein the media capture data is based on an inference and a first media;
capture a second media based on the media capture data; and
cause the transmission of the second media.

32. The apparatus of claim 31, wherein the media capture data comprises a media capture direction.

33. The apparatus of claim 31, wherein the media capture data comprises a camera control data.

34. A computer program product comprising a non-transitory computer readable medium having program code portions stored thereon, the program code portions configured, upon execution to:
receive a media capture data, wherein the media capture data is based on an inference and a first media;
capture a second media based on the media capture data; and
cause the transmission of the second media.

35. The computer program product of claim 34, wherein the media capture data comprises a media capture direction.

36. The computer program product of claim 34, wherein the media capture data comprises a camera control data.

37. A method comprising:
receiving a media or media identifier;
generating contextual data during the consumption of the media; and
causing the transmission of the contextual data.

38. An apparatus comprising at least one processor and at least one memory including computer program code, the at least one memory and computer program code configured to, with the processor, cause the apparatus at least to:
receive a media or media identifier;
generate contextual data during the consumption of the media; and
cause the transmission of the contextual data.

39. A computer program product comprising a non-transitory computer readable medium having program code portions stored thereon, the program code portions configured, upon execution to:
receive a media or media identifier;
generate contextual data during the consumption of the media; and
cause the transmission of the contextual data.
